(19) United States
(12) Patent Application Publication
(10) Pub. No.: US 2023/0418702 A1
(43) Pub. Date: Dec. 28, 2023

(54) SYSTEM LOG PATTERN ANALYSIS BY IMAGE SIMILARITY RECOGNITION

(71) Applicant: INTERNATIONAL BUSINESS MACHINES CORPORATION, ARMONK, NY (US)

(72) Inventors: Chuan Li, Shanghai (CN); Gang Lyu, Shanghai (CN); Jun Gu, Shanghai (CN); HONG ZHOU, Shanghai (CN)

(21) Appl. No.: 17/808,555

(22) Filed: Jun. 24, 2022

(51) Int. Cl. G06F 11/07; G06N 3/08

(52) U.S. Cl. CPC G06F 11/079; G06F 11/0727; G06F 11/0775; G06N 3/08

(57) ABSTRACT

The present invention may include an embodiment that identifies a log database with known error patterns. The embodiment may map the known error patterns into plurality of diagrams. The embodiment may train an artificial intelligence (AI) algorithm with the plurality of diagrams, where the AI algorithm compares diagrams and returns a distance value. The embodiment may identify logs for a new error pattern. The embodiment may map the new error pattern to a two-dimensional diagram. The embodiment may compare the two-dimensional diagram to the plurality of diagrams using the AI algorithm and identify log data of the at least one diagram based on determining a distance value is below a threshold for at least one diagram within the plurality of diagrams

### BACKGROUND

The present invention relates, generally, to the field of computing, and more particularly to intelligent system log analysis.

Logs are useful sources of information that typically describe system events, such as system faults, failures, crashes, recoveries, infiltrations, and so on in a plain language. When a system event occurs, a set of logs is generated to indicate what happens before, during, and after the event. Conventional methods of system maintenance and troubleshooting require skilled system administrators to review logs in order to identify the cause and solution to the system event.

### SUMMARY

According to one embodiment, a method, computer system, and computer program product for log pattern analysis is provided. The present invention may include an embodiment that identifies a log database with known error patterns. The embodiment may map the known error patterns into plurality of diagrams. The embodiment may train an artificial intelligence (AI) algorithm with the plurality of diagrams, where the AI algorithm compares diagrams and returns a distance value. The embodiment may identify logs for a new error pattern. The embodiment may map the new error pattern to a two-dimensional diagram. The embodiment may compare the two-dimensional diagram to the plurality of diagrams using the AI algorithm and identify log data of the at least one diagram based on determining a distance value is below a threshold for at least one diagram within the plurality of diagrams.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2A is an operational flowchart illustrating training of a log pattern analysis by image similarity recognition process according to at least one embodiment;

FIG. 2B is an operational flowchart illustrating a log pattern analysis by image similarity recognition process according to at least one embodiment;

FIGS. 3A and 3B are two-dimensional diagrams generated by a log pattern analysis by image similarity recognition process according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to intelligent system log analysis. The following described exemplary embodiments provide a system, method, and program product to, among other things, convert existing log information into a diagram representation and identify a harmful event sequence pattern (new error pattern) and possible ways to remediate the harmful event utilizing image similarity recognition algorithms. Therefore, the present embodiment has the capacity to improve the technical field of system log pattern analysis by enabling to locate a similar sequence pattern in the log database based on identifying similarities between graphical representation of log data where graphical representation of current log data is compared to a graphical representation of known error patterns log data to identify a similarity between the events and thus the solution to the current event.

As previously described, logs are useful sources of information that typically describe system events, such as system faults, failures, crashes, recoveries, infiltrations, and so on. When a system event occurs, a set of logs is generated to indicate what happens before, during, and after the event. Conventional methods of system maintenance and troubleshooting require system administrators to review logs in order to identify the cause and solution to the system event.

Typically, when an adverse event occurs, it may trigger secondary issues on other sub-components of the service or software/hardware product. The impact of the initial event may spread across the computerized system and cause an events storm. Thus, the log repository is typically filled with overwhelming log data entries that appears chaotic to an inexperienced user. The fault analysis and troubleshooting frequently depends on the reading and detailed analysis of the log files by a professional. Frequently, identifying the event that caused the collapse is difficult due to unfamiliarity of the professional with each sub-system's logs, especially in a short timeframe. As such, it may be advantageous to, among other things, implement a system that maps known error patterns and the current event sequences into images, such as a two-dimensional scatter diagram. The images may be compared using a neural network to identify similar images machine learning or constellation detection and thus a quick resolution to the event may be identified and performed automatically without human intervention.

According to one embodiment, the existing log database may be mapped into a plurality of images and then a neural network may be trained to recognize similarities of a current diagram that represents log data of a current event to a diagram of previous events stored in a database. Furthermore, a distance between the current image and the plurality of images in the database may be determined in order to find a similar event sequence in the database. When a distance between the current image and a known image in the database is below a threshold value, the resolution of the determined known event may be applied to resolve the current event.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to convert existing log database into a plurality of images and, when an event occurs, determine a resolution to the event based on comparing the converted to an image current log data to the plurality of images, where the comparison is performed using trained neural network.

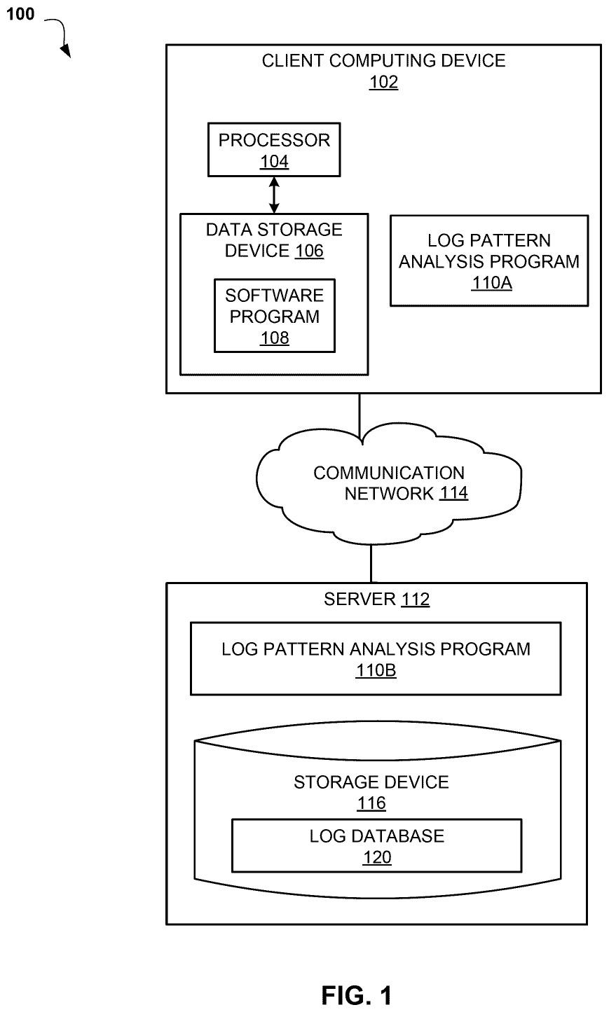

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

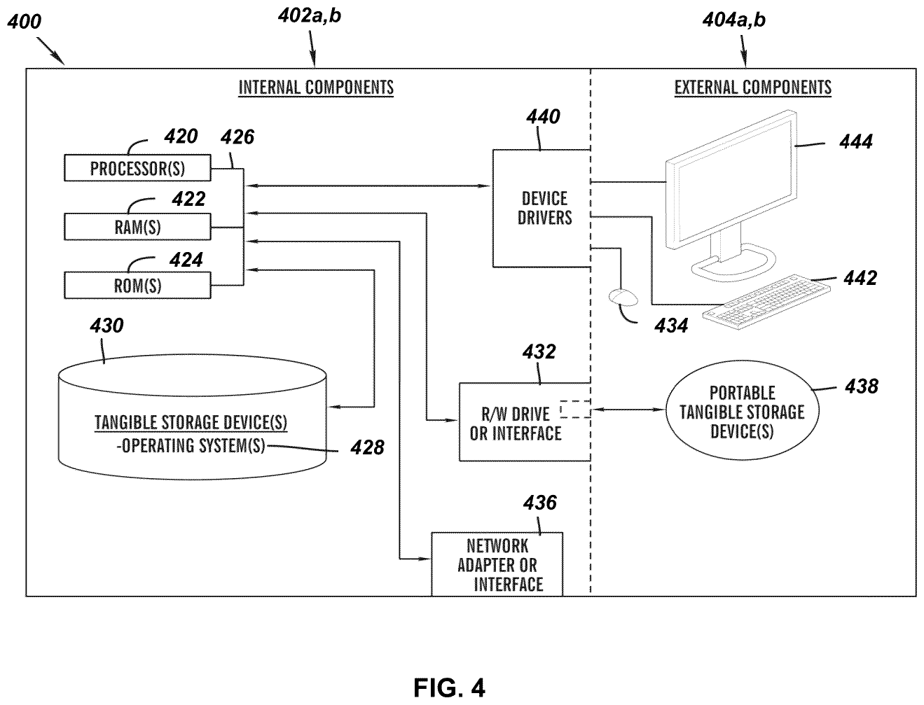

Client computing device 102 may include a processor 104 and a data storage device 106 that is enabled to host and run a software program 108 and a log pattern analysis program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server 112 may be a laptop computer, netbook computer, personal computer (PC), a desktop computer, or any programmable electronic device or any network of programmable electronic devices capable of hosting and running a log pattern analysis program 110B and a storage device 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud. The storage device 116 may store log database 120. According to an example embodiment, log database 120 may store records of various harmful events and error logs that are known and with instructions such as commands to resolved that are associated to the events.

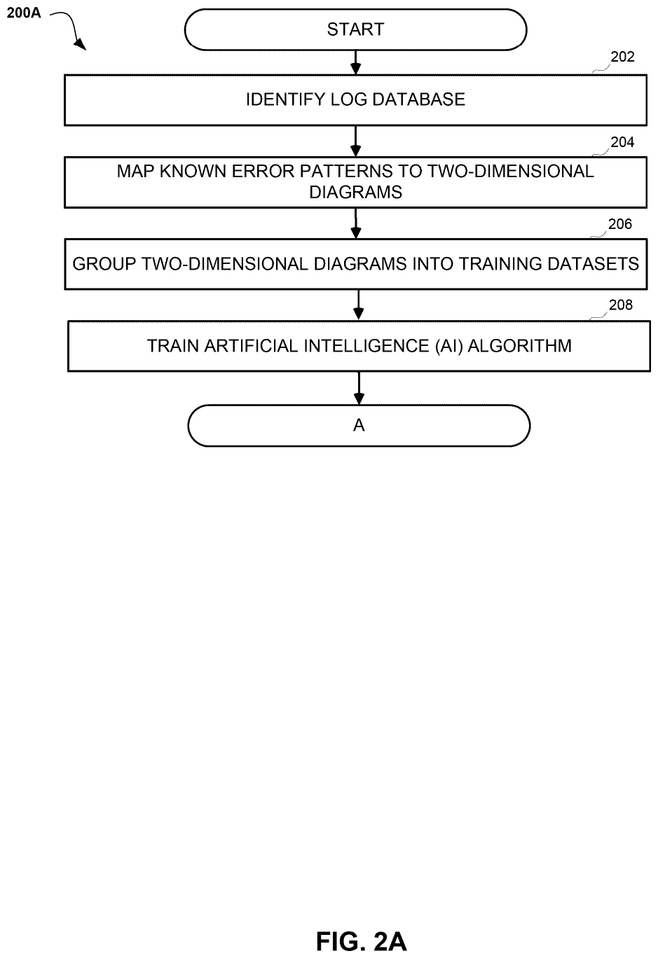

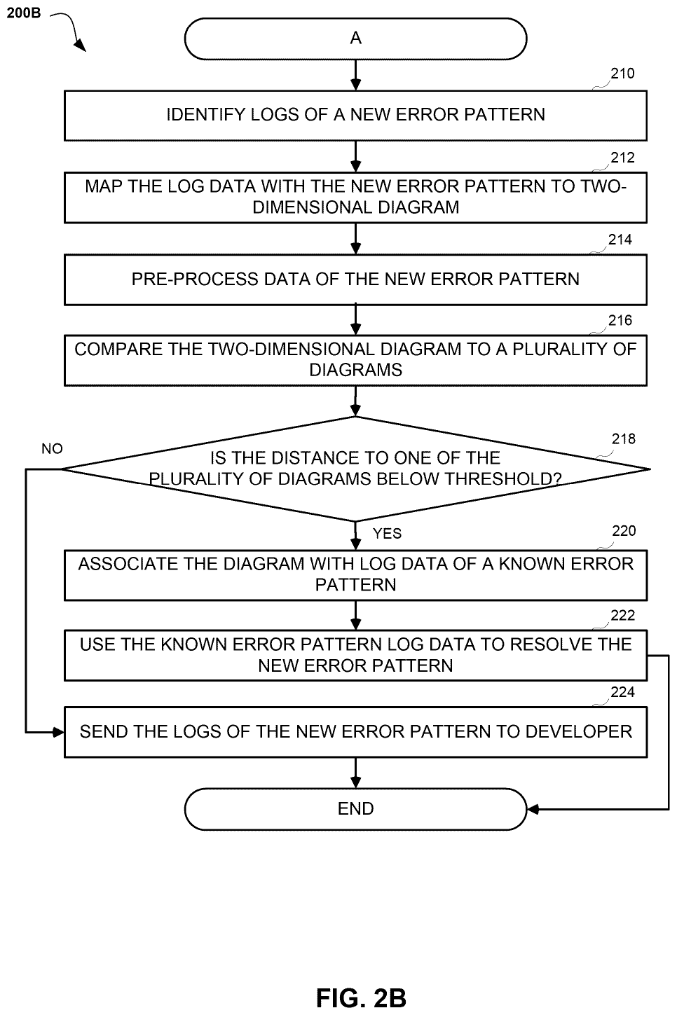

According to the present embodiment, the log pattern analysis program 110A, 110B may be a program capable of converting log database 120 into a plurality of images, training a neural network to recognize similarity between images and, after receipt of a current image representing the log data of a current event, determine the corresponding resolution of an event based on comparing the current image to the plurality of images. The log pattern analysis by image similarity recognition method is explained in further detail below with respect to FIGS. 2A-2B.

Referring now to FIG. 2A, a training of a log pattern analysis by image similarity recognition process 200A is depicted according to at least one embodiment. The process 200A may be performed either once or every time before the process 200B depicted in FIG. 2B below. At 202, the log pattern analysis program 110A, 110B identifies a log database. According to an example embodiment, the log pattern analysis program 110A, 110B may request a user, using a graphical user interface (GUI) or a command line interface (CLI) to identify and enter a location or a path to log database 120 using keyboard or mouse. In another embodiment, multiple databases from plurality of servers may be identified and analyzed by the log pattern analysis program 110A, 110B. In further embodiment, the log pattern analysis program 110A, 110B may search for the log data automatically based on specific instructions in the log. For example, if an error message was generated during a specific time, the log pattern analysis program 110A, 110B may search for all of the log files that have entries at the same specific time and aggregate them into one log data for mapping.

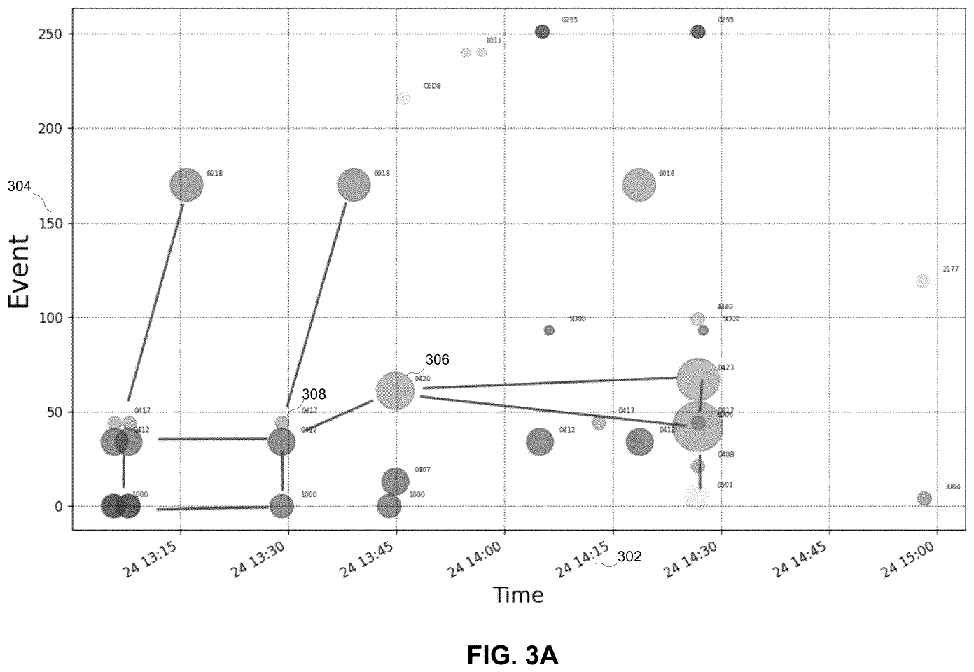

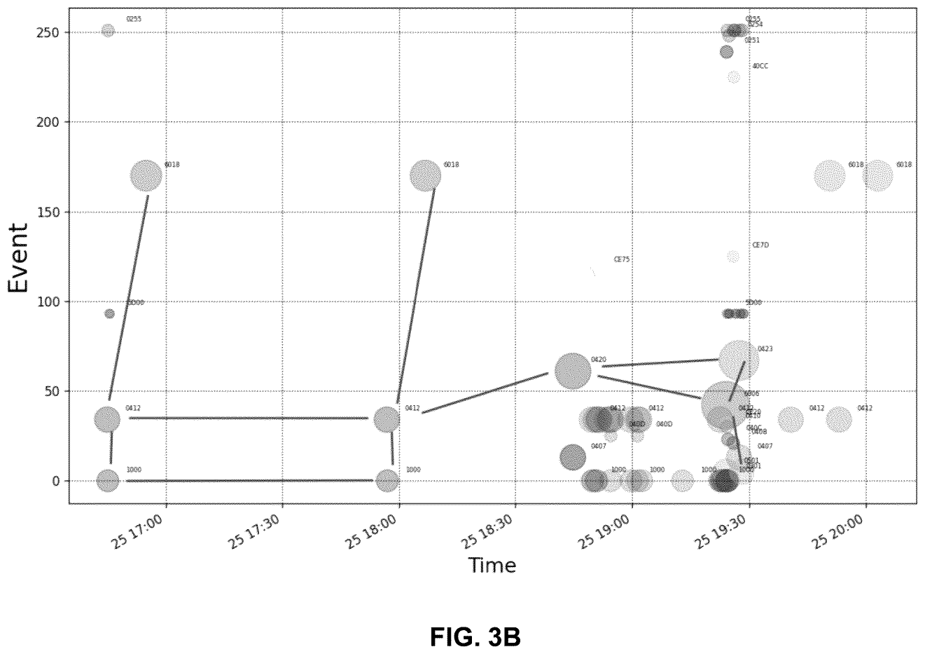

Next, at 204, the log pattern analysis program 110A, 110B maps known error patterns to two-dimensional diagrams. According to an example embodiment, the log pattern analysis program 110A, 110B may convert an event log of a known error pattern to a two-dimensional scatter diagram depicting each event as a circle having coordinates based on a timestamp and an event number. In another embodiment, the two-dimensional scatter diagram may depict each event in any other shape such as bubble, triangle etc. For example, the first dimension (X) may be a timestamp or a sequence of each log entry while the other dimension (Y) may be based on an event code. Each event code may be comprised from a combination of sub-component code and sub-event code, where the subcomponent may be assigned a predetermined color and the event code is mapped to a Y axis (See FIGS. 3A and 3B). Furthermore, the log pattern analysis program 110A, 110B may depict a severity level by increasing the size of a circle when the severity is higher, thus making the event more notable. According to an example embodiment, the log pattern analysis program 110A, 110B may use a table of severity levels, predefined by the user, for each typical log entry. In another embodiments, the log pattern analysis program 110A, 110B may assign severity automatically based on an occurrence of an event, such as higher occurrence of the same event in the log is assigned higher severity. For example, the log pattern analysis program 110A, 110B may utilize a TF-IDF algorithm to assign severity to each event in the log.

Then, at 206, the log pattern analysis program 110A, 110B groups two-dimensional diagrams into training datasets. According to an example embodiment, the log pattern analysis program 110A, 110B may generate multiple datasets for training machine learning or constellation detection algorithms. For example, a Siamese neural network may be trained using a supervised and unsupervised training methods. Thus, the two-dimensional diagrams are clustered into groups using distance metric such as Euclidian Distance or K-means clustering algorithms for various training sets. Furthermore, the log pattern analysis program 110A, 110B may generate duplicates of the two-dimensional diagrams for generation of additional training sets, when existing log data is insufficient. In another embodiment, the log pattern analysis program 110A, 110B may store the results of a clustering of similar error patterns for faster search and identification of similar patterns of events in log database.

Next, at 208, the log pattern analysis program 110A, 110B trains an artificial intelligence algorithm. According to an example embodiment, the log pattern analysis program 110A, 110B may use a convolutional neural network (CNN), such as a Siamese neural network, for image similarity comparison that typically returns as an output a vector that represents a distance between the images, thus a clustered training set may be used for training, knowing that the output should represent a distance below a predefined threshold. In another embodiment, different AI algorithms may be trained by the log pattern analysis program 110A, 110B, such as residual neural network (ResNet).

Referring now to FIG. 2B, a log pattern analysis by image similarity recognition process 200B is depicted according to at least one embodiment. At 210, the log pattern analysis program 110A, 110B identifies logs of a new error pattern. According to an example embodiment, the log pattern analysis program 110A, 110B may identify the log data with the new error pattern based on determining an error in one or more log files. For example, a line of log data may contain a term, such as “error, “failure”, “warning”, etc. In another embodiment, a user may identify a new error pattern using a GUI of the log pattern analysis program 110A, 110B.

Next, at 212, the log pattern analysis program 110A, 110B maps the log data with the new error pattern to a two-dimensional diagram. According to an example embodiment, the log pattern analysis program 110A, 110B may convert the log data to a two-dimensional scatter diagram. As previously mentioned, the log pattern analysis program 110A, 110B may use a first dimension (X axis) as representing a timestamp or a sequence of each log entry while the other dimension (Y axis) as an event code, extracted from the log. Each event code may be comprised from a combination of sub-component code and sub-event code, where the subcomponent may be assigned a predetermined color and the event code is mapped to a Y axis (See FIGS. 3A and 3B). Furthermore, the log pattern analysis program 110A, 110B may depict a severity level by increasing the size of a circle when the severity is higher, thus making the event more notable. According to an example embodiment, the log pattern analysis program 110A, 110B may use a user-predefined table of severity levels for each typical log entry. In another embodiment, the log pattern analysis program 110A, 110B may assign severity automatically based on an occurrence of an event, such as higher occurrence of the same event in the log is assigned a higher severity.

Then, at 214, the log pattern analysis program 110A, 110B pre-processes data of the new error pattern. According to an example embodiment, the log pattern analysis program 110A, 110B may display the two-dimensional diagram to a user and enable manual selection, using a GUI, of the time scope that is related to the problem analysis and aligns the two-dimensional diagram according to the time scope. For example, if a user wants to analyze the timeframe between 13:15 to 15:00, the log pattern analysis program 110A, 110B may cut all of the other data from the diagram (see FIG. 3A).

Next, at 216, the log pattern analysis program 110A, 110B compares the two-dimensional diagram to a plurality of two-dimensional diagrams. According to an example embodiment, the log pattern analysis program 110A, 110B may use the AI algorithm (see step 208) to compare the two-dimensional diagram of the new error pattern to any known error patterns from the log database 120 that were used to train the AI.

Then, at 218, the log pattern analysis program 110A, 110B determines whether the distance to one of the plurality of diagrams is below threshold. As previously mentioned, the AI algorithm returns a distance value or a distance vector representing a similarity between the diagrams. When the distance is below a threshold value, it represents that the diagrams are similar. If the log pattern analysis program 110A, 110B determines that the distance is below threshold (step 218, “YES” branch), the log pattern analysis program 110A, 110B may continue to step 230 to identify the associated with the diagram log data. If the log pattern analysis program 110A, 110B determines that the distance value between the diagrams is above the threshold (step 218, “NO” branch), the log pattern analysis program 110A, 110B may continue to step 224 to send the logs of the new error pattern to developer.

Next, at 220, the log pattern analysis program 110A, 110B associates the diagram with log data of a known error pattern. According to an example embodiment, the log pattern analysis program 110A, 110B may index each of the plurality of diagrams generated from the events of error patterns in log database 120 and associate the diagram with the underlying known error pattern log data and solution to the known error pattern, if available. In another embodiment, the log pattern analysis program 110A, 110B may extract the timestamp data from the diagram and search for the extracted timestamp values in the log database 120 to identify the known error pattern.

Then, at 222, the log pattern analysis program 110A, 110B uses the known error pattern log data to resolve the new error pattern. According to an example embodiment, the log pattern analysis program 110A, 110B may display to the user the known error pattern log data from log database 120 and the associated diagram. The log database 120 may include instructions to resolve the error pattern if executed by the log pattern analysis program 110A, 110B. In another embodiment, the log pattern analysis program 110A, 110B may load the solution to resolve the known error pattern and execute it in order to resolve the current error pattern.

Next, at 224, the log pattern analysis program 110A, 110B sends the logs of the new error pattern to a user, such as a developer. According to an example embodiment, the log pattern analysis program 110A, 110B, after determining that the new error pattern is not similar to any of the recorded events in the log database 120, may email the logs of the new error pattern to the responsible developer for analysis and a determination of a preferable resolution to be added to the log database 120. In another embodiment, the log pattern analysis program 110A, 110B may request a resolution from the developer and add it to the log database 120 for further training of the AI algorithm.

It may be appreciated that FIGS. 2A-2B provide only an illustration of one implementation and does not imply any limitations with regard to how different embodiments may be implemented. Many modifications to the depicted environments may be made based on design and implementation requirements. For example, the log pattern analysis program 110A, 110B may analyze the logs on a daily basis in order to perform health and anomaly checks of the system. In another embodiment, the log pattern analysis program 110A, 110B may perform real time error pattern detection and report/mitigation.

FIGS. 3A and 3B are two-dimensional diagrams generated by a log pattern analysis process according to at least one embodiment. As an example, FIG. 3A depicts a diagram of a current error pattern and FIG. 3B depicts a known error pattern stored in log database 120. As previously mentioned, the log data of an error pattern is represented by a two-dimensional scatter diagram.

According to an example embodiment, first dimension (X axis) is representing a timestamp or a sequence of each log entry, such as timestamp 302 while the second dimension (Y axis) depicts an event code 304, extracted from the log. Each event code may be comprised of a combination of sub-component code and sub-event code, where the subcomponent may be assigned a predetermined color and the event code is mapped to Y axis. The severity level may be depicted by an increased size of a circle when the severity is higher such as an event 306 has higher severity thus larger than event 308. Lines connected between events are added to emphasize a similarity between the depicted diagrams that may be identified using an AI algorithm such as a constellation detection algorithm.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402a,b and external components 404a,b illustrated in FIG. 4. Each of the sets of internal components 402 include one or more processors 320, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the log pattern analysis program 110A in the client computing device 102, and the log pattern analysis program 110B in the server 112 are stored on one or more of the respective computer-readable tangible storage devices 430 for execution by one or more of the respective processors 320 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the log pattern analysis program 110A, 110B, can be stored on one or more of the respective portable computer-readable tangible storage devices 438, read via the respective R/W drive or interface 432, and loaded into the respective hard drive 430.

Each set of internal components 402a,b also includes network adapters or interfaces 436 such as a TCP/IP adapter cards, wireless Wi-Fi interface cards, or 3G or 4G wireless interface cards or other wired or wireless communication links. The software program 108 and the log pattern analysis program 110A in the client computing device 102 and the log pattern analysis program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the log pattern analysis program 110A in the client computing device 102 and the log pattern analysis program 110B in the server 112 are loaded into the respective hard drive 430. The network may comprise copper wires, optical fibers, wireless transmission, routers, firewalls, switches, gateway computers and/or edge servers.

Each of the sets of external components 404a,b can include a computer display monitor 444, a keyboard 442, and a computer mouse 434. External components 404a,b can also include touch screens, virtual keyboards, touch pads, pointing devices, and other human interface devices. Each of the sets of internal components 402a,b also includes device drivers 340 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

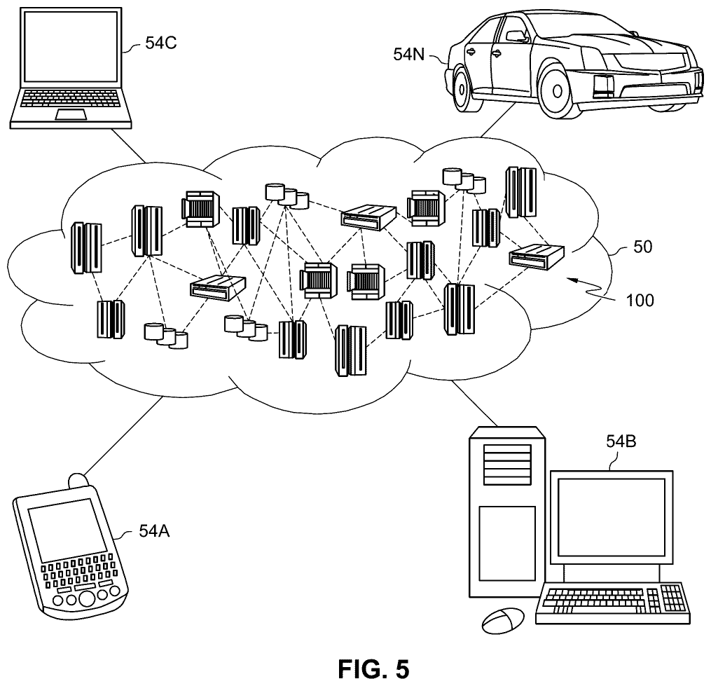

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

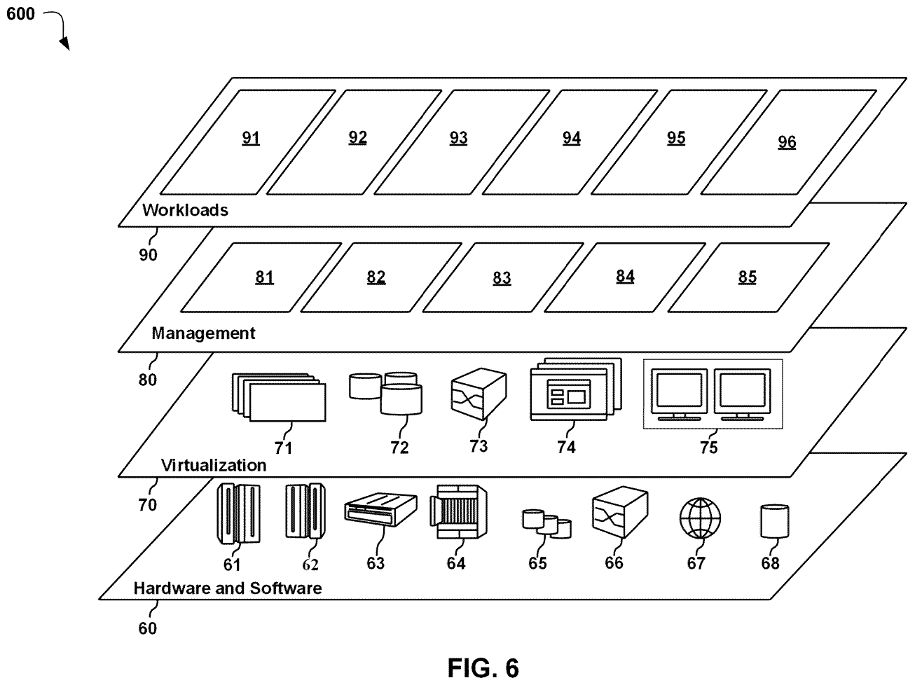

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94;

transaction processing 95; and log pattern analysis by image similarity recognition 96. Log pattern analysis by image similarity recognition 96 may relate to converting existing known error patterns log data into datasets for training an AI algorithm and then utilizing the AI algorithm to identify a similarity of a new error pattern by converting the log data of the new error pattern into a diagram and using the AI algorithm to identify similar diagram in the known log data.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for log pattern analysis, the method comprising:
identifying a log database with known error patterns;
mapping the known error patterns from the log database into plurality of diagrams;
training an artificial intelligence (AI) algorithm with the plurality of diagrams, wherein the AI algorithm compares diagrams and returns a distance value;
identifying logs of a new error pattern;
mapping the new error pattern to a two-dimensional diagram;
comparing the two-dimensional diagram to the plurality of diagrams using the AI algorithm; and
based on determining a distance value is below a threshold for at least one diagram within the plurality of diagrams, identifying log data of the at least one diagram.

2. The method of claim 1, wherein the log database with known error patterns comprises a solution to at least one of the known error patterns.

3. The method of claim 2, further comprising,
using the solution to the at least one diagram to resolve the new error pattern.

4. The method of claim 1, wherein the AI algorithm is a Siamese neural network.

5. The method of claim 1, wherein the AI algorithm is a constellation detection algorithm.

6. The method of claim 1, wherein mapping the known error patterns from the log database into the plurality of diagrams depicts each event as a circle having coordinates based on a timestamp and an event number.

7. The method of claim 1, further comprising:
displaying the two-dimensional diagram to a user;
enabling, through a graphical user interface, the user to select a time scope for the two-dimensional diagram; and
aligning the two-dimensional diagram according to the time scope.

8. A computer system for log pattern analysis, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a log database with known error patterns;
mapping the known error patterns from the log database into plurality of diagrams;
training an artificial intelligence (AI) algorithm with the plurality of diagrams, wherein the AI algorithm compares diagrams and returns a distance value;
identifying logs of a new error pattern;
mapping the new error pattern to a two-dimensional diagram;
comparing the two-dimensional diagram to the plurality of diagrams using the AI algorithm; and
based on determining a distance value is below a threshold for at least one diagram within the plurality of diagrams, identifying log data of the at least one diagram.

9. The computer system of claim 8, wherein the log database with known error patterns comprises a solution to at least one of the known error patterns.

10. The computer system of claim 9, further comprising,
using the solution to the at least one diagram to resolve the new error pattern.

11. The computer system of claim 8, wherein the AI algorithm is a Siamese neural network.

12. The computer system of claim 8, wherein the AI algorithm is a constellation detection algorithm.

13. The computer system of claim 8, wherein mapping the known error patterns from the log database into the plurality of diagrams depicts each event as a circle having coordinates based on a timestamp and an event number.

14. The computer system of claim 8, further comprising:
displaying the two-dimensional diagram to a user;
enabling, through a graphical user interface, the user to select a time scope for the two-dimensional diagram; and
aligning the two-dimensional diagram according to the time scope.

15. A computer program product for log pattern analysis , the computer program product comprising:
one or more computer-readable tangible storage medium and program instructions stored on at least one of the one or more tangible storage medium, the program instructions executable by a processor, the program instructions comprising:
program instructions to identify a log database with known error patterns;
program instructions to map the known error patterns from the log database into plurality of diagrams;
program instructions to train an artificial intelligence (AI) algorithm with the plurality of diagrams, wherein the AI algorithm compares diagrams and returns a distance value;
program instructions to identify logs of a new error pattern;
program instructions to map the new error pattern to a two-dimensional diagram;
program instructions to compare the two-dimensional diagram to the plurality of diagrams using the AI algorithm; and
based on determining a distance value is below a threshold for at least one diagram within the plurality of diagrams, program instructions to identify log data of the at least one diagram.

16. The computer program product of claim 15, wherein the log database with known error patterns comprises a solution to at least one of the known error patterns.

17. The computer program product of claim 16, further comprising,
program instructions to use the solution to the at least one diagram to resolve the new error pattern.

18. The computer program product of claim 15, wherein the AI algorithm is a Siamese neural network.

19. The computer program product of claim 15, wherein the AI algorithm is a constellation detection algorithm.

20. The computer program product of claim 15, wherein program instructions to map the known error patterns from the log database into the plurality of diagrams depicts each event as a circle having coordinates based on a timestamp and an event number.
